(19) United States
(12) Patent Application Publication
(10) Pub. No.: US 2014/0260821 A1
(43) Pub. Date: Sep. 18, 2014

(54) HAMMER UNION WRENCH

(71) Applicants: Marc DUMAINE, Calgary (CA); Larry MATTHEWSON, Calgary (CA)

(72) Inventors: Marc DUMAINE, Calgary (CA); Larry MATTHEWSON, Calgary (CA)

(21) Appl. No.: 13/801,460

(22) Filed: Mar. 13, 2013

(51) Int. Cl. B25B 13/50

(52) U.S. Cl. CPC B25B 13/50
USPC 81/119

(57) ABSTRACT

A tool for actuating hammer unions. The tool provides for an arcuate tool head having a disposed variant and an aperture which receives the lug or tab of the union. Extending outwardly the arcuate tool head is a lever member which may be used to strike a surface to loosen or tighten the union or alternatively, receive a handle for increasing the amount of torque that can be applied to the union by a user. By receiving the tab in the arcuate head, the user is precluded from damaging the tabs or lugs since no impact is received by the latter and a maximum amount of work can be done safely by the user.

The present invention relates to a tool and more particularly, relates to a hammer union wrench for safely applying torque to hammer unions of all sizes.

Hammer unions are well known in the in the oil, gas and mining industry. Hammer unions are used to fasten pipe together for low and high pressure applications and as is known, these unions typically include lugs or tabs which require engagement with a hammer for tightening and loosening. As is presently conducted in this field, a worker typically actuates the union by swinging a hammer. This applies a force to the tabs or lugs in order to rotate the union into a tightening or loosening position. As such, the lugs or tabs typically incur a significant amount of force from repetitive striking. One of the problems is that despite the fact that the lugs or tabs are obviously made of the same material forming the mechanical fastener or union, metal fatigue can certainly occur after repeated strikes. This can result in breakage of the lug or tab completely from the entire body of the fastener which would then result in the lug or tab becoming a projectile presenting a dangerous situation or fragments or pieces of the lug becoming dislodged from the lug itself, acting as shrapnel. These are serious issues and can result in injury to not only the worker operating the hammer, but also surrounding members of a work team. A further problem that exists with this type of system is that the swinging of an object towards the hammer union can present a hazardous situation, particularly where a worker is not alert to his surroundings.

In order to circumvent this problem, a number of solutions have been proposed in the prior art, one of which is indicated in United States Patent Publication No. US 2012/0048069, with the published author being named as Powell Jr. In the publication, it is disclosed that the Applicant provides a hammer union wrench comprising a tool head having a substantially circular or disk shaped tool head body with an opening there through axially and transversally. The axial opening also includes slots which receive tabs associated with the hammer union. Although this is a useful arrangement, it requires the engagement of at least two of the tabs or bosses of the hammer union and fairly specific alignment of the tool head relative to the hammer union. This is not an issue in situations where the union is free of any debris, but presents difficulties in use where the union has been exposed to debris or is encumbered by ice, snow, etc. A further perceived limitation to this arrangement is that there does not appear to be any compensation for adding or augmenting the torque that is applied to the union by the worker. The arrangement provides the head of the tool in direct alignment with a stock handle shown in the drawings as number 14. Accordingly, it would appear that the worker would still have to exert a significant amount of effort to activate the tool head in order to tighten or loosen the union.

Other arrangements that are known are spanner wrenches. An example of one such arrangement is shown in U.S. Pat. No. 2,830,480, issued Apr. 15, 1958 to Brame for a spanner wrench for tubing unions. Brame provides a wrench having a semicircular tool head with a series of recesses and projections positioned on the tool head. The recesses and projections mate in registration with similarly configured recesses and projections in the tubing union. This arrangement, similar to that set forth in the publication discussed supra requires precise alignment and potentially also has the possibility of slippage from the tubing union which could result in injury during use.

Earlier attempts in the art to improve the efficiency and overall construction of such wrenches is shown in U.S. Pat. No. 464,084, issued Dec. 1, 1891, to Robinson. The Patentee provides a curved jaw tool head with a tooth positioned within the jaw and guiding ears associated therewith.

In U.S. Pat. No. 2,691,912, issued Oct. 19, 1954, Jones provides an anvil type wrench. The wrench effectively comprises a body suitable for use in pipe union fittings.

The art has presented further variations on these overall arrangements. A further example of which is demonstrated in U.S. Pat. No. 1,528,892, issued Mar. 10, 1925 to Pigott et al. The patent provides for a wrench which has a U-shaped head internally directed towards portion 8.

In view of the limitations in the art, it would appear that there is still a need for a high efficiency wrench which does not require impact or regular forces to be applied to tabs or lugs of a pipe union or hammer union which causes premature ware and the hazards noted above. The present invention not only satiates these requirements but also provides for improved arrangement where torque can be applied to the tool with a greater degree of efficiency and less effort by the worker.

One object of one embodiment of the present invention is to provide an improved wrenched suitable for use in a pipe union or hammer union environment.

One aspect of an embodiment of the present invention is to provide a tool, comprising:
an arcuate tool head;
an aperture through said head for receiving first tab means of pipe fitting;
an abutment surface on said head and spaced from said aperture for abutting second tab means adjacent said first tab means in use; and
a lever member extending from said tool head adapted to receive handle means or act as an impact surface for imparting leverage to said head.

The tool has been found to be particularly effective in field use. By virtue of the structural features of the arrangement, the tool does not result in the consistent impact of the tabs or lugs of the hammer union, but rather engages the tabs or lugs in a manner that does not significantly damage of otherwise cause metal fatigue to the lugs. This is a pronounced advantage over existing arrangements which were limited by inducing mechanical stress to the lugs themselves.

A further significant advantage to the arrangement is that alignment is expeditiously effected; the wrench provides a head that only requires engagement with a single lug and which completely surrounds the lug in a receiving relationship. The arcuate nature and structure of the tool head also provides an abutment member which abuts the surface of the adjacent lug. In this mariner, movement is quickly effected and is not so limited by the shape of the lug which may have been previously damaged by other means. This is also beneficial in that in the event that the lugs are covered with ice or other debris, such as mud, congealed oil and other material, the tool head can still be easily positioned on the hammer union owing to the fact that the tool head structure is such that the tool head overlies and receives a lug or tab. This was a significant limitation in the prior art arrangements which had to be positioned in specific alignment with two or more adjacent tabs. This would be almost impossible if lugs were out of shape or damaged in any way. With the instant arrangement, as long as there is at least some of the lug formed for the tool head to receive with an adjacent surface or partial lug, the tool can be effectively used.

In accordance with a further aspect of an embodiment of the present invention, there is provided a tool, comprising:
an arcuate tool head;
an aperture through said head for receiving first tab means of pipe fitting;
an abutment surface on said head and spaced from said aperture for abutting second tab means adjacent said first tab means in use;
a lever member extending from said tool head; and
handle means adjustably connected to said arcuate tool head.

By observing specific angular relationships, the tool head can be used on its own, absent any specific handle, as the arrangement includes a lever arm extending from the tool head 8″ inches, as an example. This can act as hand grip and is useful to receive a designed handle for additional leverage.

It has been found that by providing a bend in the handle itself, a significant effect is realized in augmented torque that can be applied to the hammer union. The handle not only is bent, but also the lever arm which is received by the handle. By making use of this dual angle relationship, the handle is angularly disposed relative to the vertical centre line of the tool head. It will be appreciated by those skilled that this presents a mechanical advantage from a force vector perspective that is to the advantage of the user where less effort is required in order to effect tightening or loosening of the hammer union.

In terms of materials, it has been found that hot rolled steel such as 50 W and 44 W is useful, although one skilled in the art will appreciate innumerable suitable alternatives have been found to be particularly useful for the opposition of the wrench.

In respect of the arrangements where the handle is used, the tool head may be interchangeable with the head itself. This would allow the handle to be used with a variety of differently sized tool heads for different hammer union arrangements.

A particularly beneficial feature of the present invention, the handle is reversible and can be positioned in two distinct ways relative to the individual tool head. This provides the user with a further degree of flexibility and/or use of the arrangement in a variety of environments. As a further advantage, it has been recognized that the tool head can be positioned closer to or further away from the terminal end of the handle. This allows for further length of the handle relative to the tool head which, of course, translates into substantial increases in the ability of the user to apply effective torque to the hammer union.

Having thus generally described the invention, references will now be made to the accompanying drawings illustrating preferred embodiments and in which:

FIG. 1 is a perspective view of one embodiment of the tool head according to the present invention;

FIG. 2 is a side view of FIG. 1;

FIG. 3 is a schematic perspective view of the arrangement of FIG. 1 in use;

FIG. 4 is a perspective view of a further embodiment of the present invention;

FIG. 5 is a perspective view of the present invention according to a further variation; and

FIG. 6 is a side view of FIG. 5.

Similar numerals employed in the figures denote similar elements.

Referring now to the drawings, FIG. 1 illustrates a first embodiment of the tool head. The overall arrangement is denoted by numeral 10. The tool head comprises an arcuate body 12 having a first end 14 and a second opposed end 16, an outside surface 18 and an inside surface 20. The tool head 12 is generally referred to as a wrench saddle plate in other terms. Disposed within the body 12 and extending therethrough is an aperture 22, shown in the example as a generally rectangular aperture which extends completely through the body 12 from the outside surface 18 to the inside surface 20. Aperture 22 is spaced from first end 14.

Turning to end 16, the example shows a generally notch shaped cutout 24 which extends through the top surface 18 and inside surface 20. The notch 24 extends upwardly into the opposed end 16 and subscribes substantially to a rectangular configuration. The rectangular configuration of notch 24 and of aperture 22 are exemplary only. Further, it will be appreciated by those skilled in the art that notch 24 is positioned within end 16 in order to provide additional stability when the wrench is engaged with the hammer union. This will be described in greater detailed herein after.

Fixedly secured to the outside surface 18 of body 12 is a lever member, globally denoted by numeral 26. As is illustrated, the lever member 26 is positioned between aperture 22 and notch 24 and includes a lever arm 28 comprising a substantially rectangular bar, in this embodiment, which merges or connects to a reinforcing structure 30 to impart rigidity to the lever arm 28. The lever arm 28 extends upwardly and away from the arcuate body 12.

With reference to FIG. 3, shown is a view of the overall arrangement 10 as positioned on a hammer union 30. As is illustrated, the hammer union 30 includes a plurality of tabs 32 or lugs arranged peripherally about the hammer union in spaced relation.

Shown in dotted lines is a tube 34 which may be used to receive lever arm 28. This obviously has advantages from a work perspective, since the equation W=F·d is dependent on distance.

The arrangement of the overall structure has been found to be particularly effective and this effectiveness is augmented by the fact that the lever member is angularly disposed relative to the tool head 12. As is illustrated in FIG. 2, the lever member is disposed in an angle of 20 degrees relative to the center line of the tool head. This provides a mechanical advantage in use and reduces the amount of labor that is required for a worker to use the wrench to loosen or tighten hammer unions.

As will be realized from the use FIG. 3, the notch is useful to provide additional stability to the tool when in position, however, it will be readily appreciated that the notch could be absent of the end 16 of the tool and that section of the body simply filled in to be a solid terminal end potion which simply abuts the adjacent lug.

Turning to FIG. 4, presented is a further embodiment of the arrangement where the tool head 12 is combined with an elongate handle 36. In this embodiment, the handle includes a connection end globally denoted by numeral 38 and an opposed end 40. In the embodiment shown in FIG. 4, handle 36 is adjustably connected to the tool 10 by the connection with the lever member 26. More specifically, the handle 36 includes a connection member 42 which comprises a socket type receptacle which receives lever arm 28 therein. This is more precisely shown in FIG. 6. Those skilled in the art will appreciate that this is one possible embodiment; any number of suitable similar mechanical connections between the handle 36 and a lever arm 28 may be used. Further, it is also fully contemplated that instead of the handle 36 having the socket 42, the lever arm 28 may simply include the socket 42 for connection with handle 36. In order to facilitate connection between the handle 36 and the socket 42, an aperture 44 extending through socket 42 through both sides of the socket 42 is provided which registers with apertures 46 associated with the handle 36. A pin 47 engages the apertures 44 and 46.

FIG. 6 illustrates additional apertures 48 and 50 joined with dashed line which may be included on handle 36 in order to extend the length of the handle further. The extension is shown towards the terminal end portion 40 in dash line represented by numerals 52 and 54. As an alternative, the additional apertures 48 and 50 can be eliminated and the handle 36 simply made longer.

As is evident from FIGS. 4 through 6, the handle 36 is angularly disposed relative to the vertical axis. It has been found that by providing a bend in the handle in this manner, additional leverage can be imparted to the wrench tool for further effective use. This is also augmented by the fact that the tool head itself and particularly the lever arm as it is connected to the body 12 prevents an angular disposition. As will be appreciated by those skilled in the art, this angular disposition allows for a higher degree of torque to be applied for loosening and tightening situations, thus, reducing the amount of labor and force required by a worker to employ the use of the tool.

It has been found that an angular disposition of 11 degrees relative to the vertical axis of the handle has been particularly effective when combined with the angular disposition of the lever arm 28 relative to the body 12.

FIG. 5 illustrates a further embodiment of the present invention where the handle is repositioned in the opposite direction to that of FIG. 4, relative to the tool head 12. This affords a greater degree of flexibility and use for the worker and permits the use of the tool in environments where there may be clearance problems or height restrictions where the tool cannot be used in the position shown in FIG. 4.

To further augment the effectiveness of the tool, the end portion 40 of the handle 36 may include a further connection member, shown in the example as an aperture presented by numeral 56. The aperture may be useful to receive a further connection device or an additional length of handle (not shown).

Although embodiments of the invention have been described above, it is not limited thereto and it will be apparent to those skilled in the art that numerous modifications form part of the present invention insofar as they do not depart from the spirit, nature and scope of the claimed and described invention.

1. A tool, comprising:
an arcuate tool head;
an aperture through said head for receiving first tab means of fitting;
an abutment surface on said head and spaced from said aperture for abutting second tab means adjacent said first tab means in use; and
a lever member extending from said tool head adapted to receive handle means or act as an impact surface for imparting leverage to said head.

2. The tool as set forth in claim 1, wherein said lever member is fixedly secured to an outside surface of said head.

3. The tool as set forth in claim 1, wherein said lever member is secured to said head between said abutment surface and said aperture.

4. The tool as set forth in claim 1, wherein said aperture surrounds said first tab means.

5. The tool as set forth in claim 1, wherein said abutment surface comprises a notch for accommodating at least a portion of said second tab means.

6. The tool as set forth in claim 5, wherein said tool head has a first end and a second end arcuately opposed there from, said notch extending within said first end.

7. The tool as set forth in claim 1, wherein said head is substantial semicircular.

8. The tool as set forth in claim 1, wherein said lever member includes a reinforcement fixedly secured to said tool head and said lever member.

9. The tool as set forth in claim 1, wherein said reinforcement is integral with said tool head and said lever member.

10. The tool as set forth in claim 8, wherein said lever member and reinforcement extend between said aperture and said abutment surface.

11. The tool as set forth in claim 1, wherein said lever member has an arm extending therefrom.

12. The tool as set forth in claim 11, wherein said arm is angularly disposed relative to the vertical centered on said tool head.

13. The tool as set forth in claim 11, wherein said arm is disposed at an angle of 20 degrees relative to the vertical.

14. The tool as set forth in claim 11, wherein said arm of said lever includes connection means adapted to connect with ancillary extension for imparting leverage.

15. A tool, comprising:
an arcuate tool head;
an aperture through said head for receiving first tab means of pipe fitting;
an abutment surface on said head and spaced from said aperture for abutting second tab means adjacent said first tab means in use;
a lever member extending from said tool head; and
handle means adjustably connected to said arcuate tool head.

16. The tool as set forth in claim 15, wherein said handle having a connection end and an opposed second end and including a bend proximate said connection end.

17. The tool as set forth in claim 16, wherein said bend is an 11 degree bend relative to the vertical axis of said handle.

18. The tool as set forth in claim 17, wherein said handle further includes second connection means proximate said opposed end.

19. The tool as set forth in claim 15, wherein said lever member includes a lever arm.

20. The tool as set forth in any one of claims 1 through 18, wherein said tool is an integral one piece structure.
